(19) United States
(12) Patent Application Publication
(10) Pub. No.: US 2023/0327386 A1
(43) Pub. Date: Oct. 12, 2023

(54) USB-C TO BARREL POWER ADAPTERS

(71) Applicant: TARGUS INTERNATIONAL LLC, Anaheim, CA (US)

(72) Inventors: Man Cheung Dan Tsang, Carlsbad, CA (US); Michael Alan Sexton, Ladera Ranch, CA (US); Kam Shing Lee, Hong Kong (CN)

(21) Appl. No.: 17/658,405

(22) Filed: Apr. 7, 2022

(51) Int. Cl. H01R 31/06; H01R 27/02; H02H 3/10

(52) U.S. Cl. CPC H01R 31/065; H01R 27/02; H02H 3/10

(57) ABSTRACT

Power adapters having Universal Serial Bus (USB) Type-C (USB-C) receptacles acting in a USB Power Delivery (USB-PD) sink mode are disclosed herein. The USB-C receptacle can be connected to a USB-PD source via a USB-C cable. The power adapter further includes a socket in electrical communication with the USB-C receptacle that receives a removable (interchangeable) barrel plug of a size corresponding to the barrel receptacle of an output device to be powered by the power adapter. The power adapter uses a USB-PD controller to communicate with the USB-PD source via the USB-C receptacle to request that power be provided at a desired direct current (DC) voltage by the USB-PD source to the USB-C receptacle. The power so received is then delivered between the USB-C receptacle and the socket. From the socket, the power travels through the attached removable barrel plug and to the barrel receptacle of the output device.

### BACKGROUND

The use of Universal Serial Bus (USB) Type-C (USB-C) connectors is becoming more frequent. One way in which USB-C connectors are leveraged is for power transport. As one example, USB Power Delivery (USB-PD) standards have been developed that define how a USB-C port that is a USB-PD source port (or USB-PD source) can provide (e.g., via a USB-C cable) power to a USB-C port that is a USB-PD sink port (or USB-PD sink) hosted on another device (e.g., in order to power the other device). This may occur according to defined procedures of the USB-PD standard that allow for, for example, the USB-PD sink to request a given power level (e.g., voltage and/or current) from the USB-PD source.

However, many devices are not equipped with such a USB-PD sink. For example, rather than receiving power at a USB-C receptacle that can operate according to USB-PD methodologies, many devices are instead configured to receive power at a barrel receptacle of the device, where the barrel receptacle is configured to receive a barrel plug that provides the barrel receptacle a pre-assumed direct current (DC) voltage (and that sources an appropriate current at that DC voltage for the device).

### BRIEF SUMMARY

A power adapter as disclosed herein may include a USB-C receptacle of an included USB-PD sink. The USB-C receptacle may be connected to a USB-PD source via a USB-C cable. The power adapter uses the USB-C receptacle (in the USB-PD sink mode) to request and subsequently receive power from the USB-PD source at a desired direct current (DC) voltage that is appropriate for use with an output device that receives power via a barrel receptacle.

A socket of the power adapter that is in electrical communication with the USB-C receptacle receives a removable (interchangeable) barrel plug of a size corresponding to the barrel receptacle of the output device. The power adapter facilitates the delivery of the power (at the desired DC voltage previously requested by the power adapter) from the USB-PD source and through the power adapter to the removable barrel plug. The output device can then be powered via the insertion of this removable barrel plug into the barrel receptacle of the output device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a power adapter, according to an embodiment.

FIG. 2 illustrates a system including a power adapter attached to both a USB-PD source of a USB-PD source host device and a removable barrel plug, according to an embodiment.

FIGS. 3A-3B illustrate a pair of views of a socket of a power adapter, according to an embodiment.

FIGS. 4A-4E illustrate various views of a removable barrel plug, according to an embodiment.

FIG. 5 illustrates a diagram showing the connection between a power adapter, a USB-PD source, and an output device, according to an embodiment.

FIG. 6 illustrates a method of a power adapter, according to an embodiment.

FIGS. 7A-7B illustrate a pinout of a USB-C receptacle, according to an embodiment.

FIG. 8 illustrates a logical architecture of a provider and a consumer in a USB-PD relationship, according to an embodiment.

FIGS. 9A-9D together illustrate a flow diagram for establishing a power contract between a USB-PD source and a USB-PD sink when using Standard Power Range (SPR), according to an embodiment.

FIGS. 10A-10D together illustrate a flow diagram for establishing a power contract between a USB-PD source and a USB-PD sink when using Extended Power Range (EPR), according to an embodiment.

### DETAILED DESCRIPTION

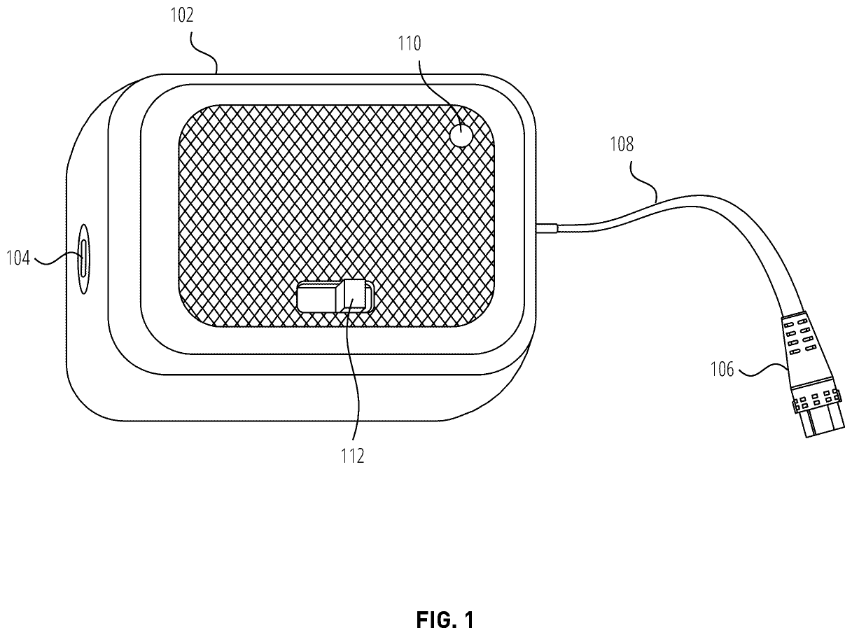

FIG. 1 illustrates a power adapter 102, according to an embodiment. The power adapter 102 includes a USB-C receptacle 104 and a socket 106.

The USB-C receptacle 104 may be used by the power adapter 102 to operate in a USB-PD mode. Specifically, the USB-C receptacle 104 may be able to operate as/be part of a USB-PD sink of the power adapter 102 via a connection with a USB-PD source at/through the USB-C receptacle 104.

The socket 106 may be configured to receive a removable barrel plug (not illustrated in FIG. 1). The power adapter 102 may be configured to deliver power between the USB-C receptacle 104 and the socket 106 (e.g., from the USB-C receptacle 104 to the socket 106). The socket 106 may then provide any of that delivered power at any attached removable barrel plug. This power may be provided to the power adapter 102 at the USB-C receptacle 104 from an attached USB-PD source according to the operation of the USB-C receptacle 104 of the power adapter 102 as a USB-PD sink.

The power adapter 102 of the embodiment of FIG. 1 illustrates that the socket 106 is present on the end of a cable 108 of the power adapter 102. While this cable 108 is not strictly required, the provision of the socket 106 on the end of the cable 108 may facilitate easier/simpler physical placement of the socket 106 (and any attached removable barrel adapter) due to the flexibility and range of movement provided by the cable 108.

The power adapter 102 may further include a light emitting diode (LED) 110. The LED 110 may provide an indication (e.g., illumination) when the power adapter 102 is attached to a USB-PD source and accordingly the USB-C receptacle 104 is currently functioning as a USB-PD sink, and/or when the power adapter 102 is actively delivering any received power (from the USB-PD source) between the USB-C receptacle 104 and the socket 106.

The power adapter 102 may further include a user switch 112. The user switch 112 may provide the user with a manner of controlling power delivery between the USB-C receptacle 104 and the socket 106 of the power adapter 102 (e.g., may provide the user with a manner to interrupt the power delivery between the USB-C receptacle 104 and the socket 106). In some embodiments, engaging the user switch 112 to interrupt this power delivery may also cause the LED 110 to turn off.

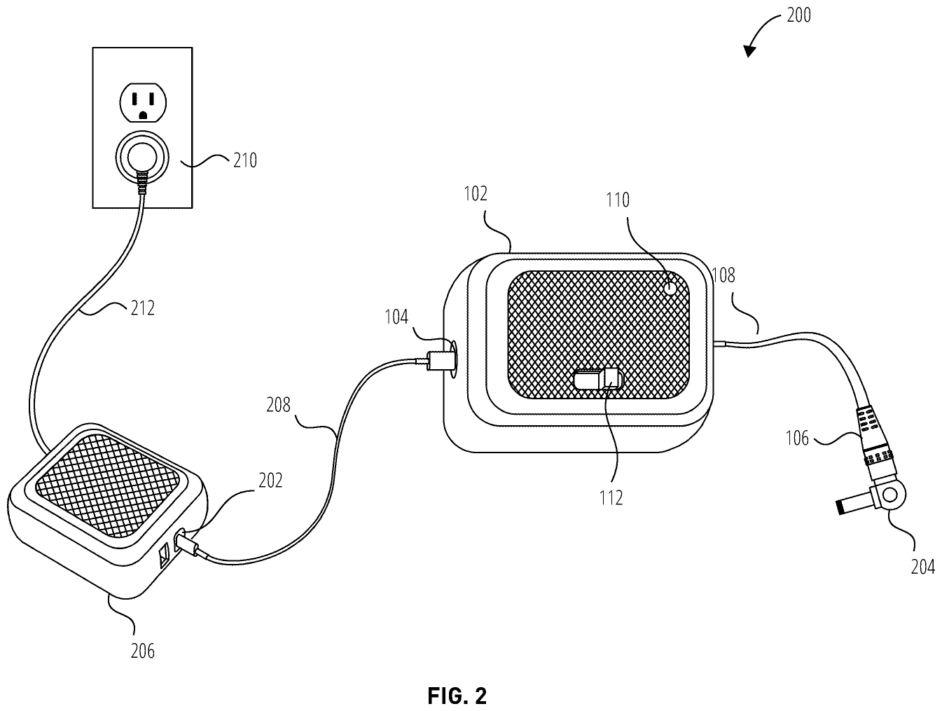

FIG. 2 illustrates a system 200 including the power adapter 102 attached to both a USB-PD source 202 of a USB-PD source host device 206 and a removable barrel plug 204, according to an embodiment. As illustrated, the USB-PD source 202 is (also) a USB-C receptacle, and the USB-C receptacle 104 of the power adapter 102 (which may act as a USB-PD sink) has been connected to the USB-PD source 202 via a USB-C cable 208.

The USB-PD source 202 provides power to the USB-C receptacle 104 of the power adapter 102 via the USB-C cable 208 and according to USB-PD methodologies. FIG. 2 illustrates a case where the USB-PD source host device 206 hosting the USB-PD source 202 receives power (that is then used at the USB-PD source 202) from the outlet 210 via the power cable 212. It is noted that this is simply one possible example embodiment for the USB-PD source host device 206. It is contemplated that a device capable of hosting the USB-PD source 202 could instead be battery powered, powered by some other external power source (e.g., other than the outlet 210), etc.

In FIG. 2, a removable barrel plug 204 has been illustrated as attached to the socket 106 of the power adapter 102. This removable barrel plug 204 may interface with the socket 106 such that it receives the power that is delivered to the socket 106 of the power adapter 102 (as sourced from the USB-PD source 202 and delivered between the USB-C receptacle 104 and the socket 106 of the power adapter 102).

The removable barrel plug 204 may then accordingly be inserted into a barrel receptacle of an output device (not shown in FIG. 2) in order to deliver this power to the output device. Accordingly, through the use of the power adapter 102, power from a USB-PD source 202 may be ultimately delivered to and used by an output device that uses a barrel receptacle to receive that power.

Due to the diverse possible sizes of barrel receptacles, it is contemplated that the removable barrel plug 204 could be removed from the socket 106 and replaced (or interchanged) with a second removeable barrel plug (of a different size) in order to allow operation of the power adapter 102 with (another) output device that uses a different-sized barrel receptacle.

In sum, the power adapter 102 provides interoperability between USB-PD sources and output devices that are not themselves USB-PD compliant/equipped with USB-PD sinks but that instead use barrel receptacle power inputs to receive power. Thus, the use of the power adapter 102 as illustrated in FIG. 2 extends the utility of USB-PD sources (when used with the power adapter 102) into ultimate use cases where they may not otherwise be able to be used.

It is noted that while discussion herein describes the use of removable barrel plugs, it is contemplated that other types of removable plugs (other than barrel plugs) could be manufactured for use with the socket 106/the power adapter 102 (e.g., in the case of a device that uses something other than a barrel jack for receiving power).

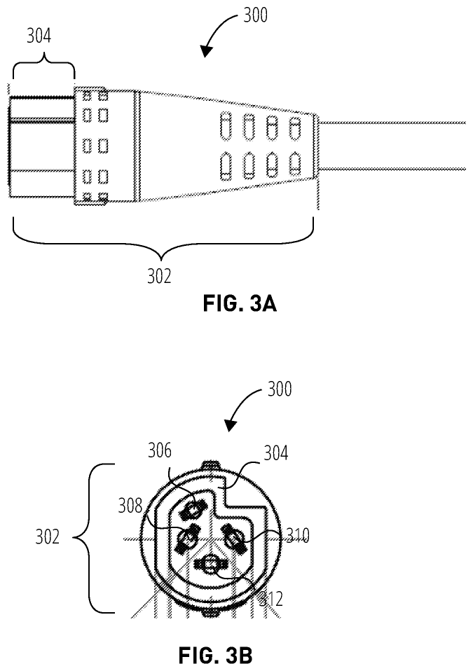

FIG. 3A and FIG. 3B illustrate a pair of views of a socket 300 of a power adapter, according to an embodiment. A body 302 of the socket 300 may be made of plastic, rubber, or any other suitable material.

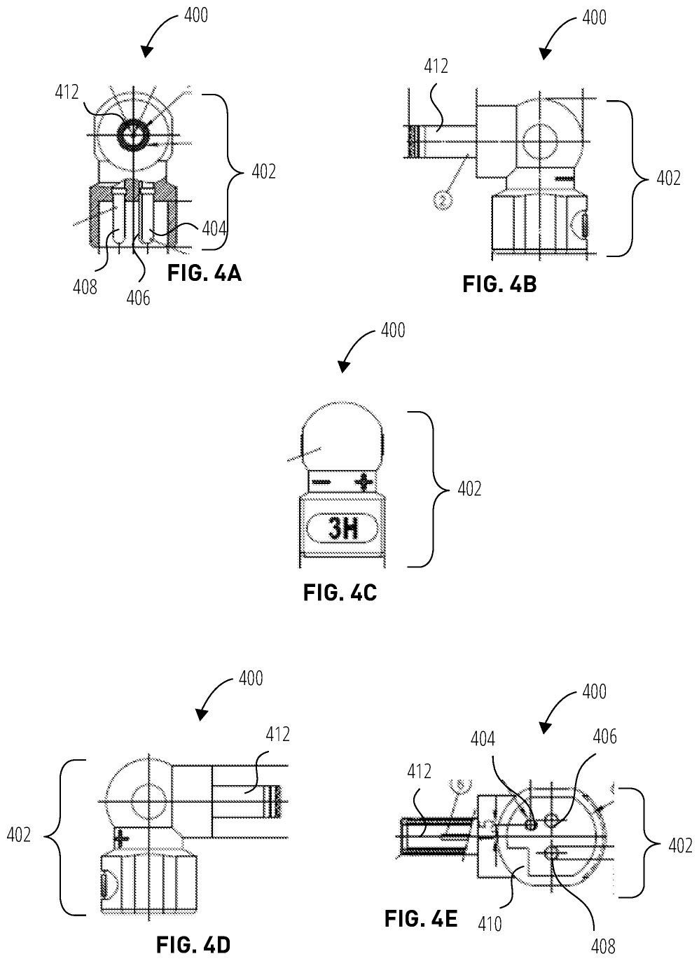

As illustrated, the body 302 of the socket 300 includes a shaped portion 304. The shaped portion 304 of the socket 300 may be shaped to match a shaped portion of a removeable barrel plug (such as the shaped portion 410 of the removable barrel plug 400 of FIG. 4E). This shaping may cause the removable barrel plug to be received at/in the socket 300 with a correct orientation.

As seen in FIG. 3B, the socket 300 includes the first pin receptacle 306, the second pin receptacle 308, the third pin receptacle 310, and the fourth pin receptacle 312. One or more of these pin receptacles 306 through 312 may receive one or more pins of a removable barrel plug that is to be received by the socket 300. One or more of the pin receptacles 306 through 312 may be arranged (placed within the socket 300) such that they receive corresponding one or more pins of an attached removable barrel plug with a correct orientation. For example, the first pin receptacle 306, the second pin receptacle 308, and the third pin receptacle 310 have been arranged such that pins 404 through 408 of the removable barrel plug 400 (as illustrated in FIG. 4A and FIG. 4E) are received with a correct orientation.

It is noted that while the socket 300 includes four pin receptacles (the first pin receptacle 306 through the fourth pin receptacle 312), not all of these pin receptacles may be used/filled by a pin when a removable barrel plug is attached to the socket in every possible embodiment. As can be seen, when, for example, the removable barrel plug 400 is attached to the socket 300, only the first pin receptacle 306, the second pin receptacle 308, and the third pin receptacle 310 are used, and the fourth pin receptacle 312 is not used (see the (three) pins 404 through 408 of the removable barrel plug 400 of FIG. 4A and FIG. 4E). It is further noted that in such an embodiment, the use of the first pin receptacle 306, the second pin receptacle 308, and the third pin receptacle 310 is sufficient (e.g., without the further use of the fourth pin receptacle 312) to ensure the proper pin orientation between the socket 300 and the removable barrel plug 400 as described.

One or more of the pin receptacles 306 through 312 of the socket 300 may be made up of electrically conductive material that provides electrical communication of the power at the desired DC voltage that is present at the socket 300 to any inserted pins of a removable barrel plug (such as one or more corresponding pins 404 through 408 of the removable barrel plug 400). For example, it may be that the second pin receptacle 308 provides the positive connection for the desired DC voltage and the third pin receptacle 310 provides the negative connection for the desired DC voltage.

FIG. 4A, FIG. 4B, FIG. 4C, FIG. 4D, and FIG. 4E illustrate various views of a removable barrel plug 400, according to an embodiment. A body 402 of the removable barrel plug 400 may be made of plastic, rubber, or any other suitable material. Note that in the front view of FIG. 4A, a front bottom portion of the body 402 has been cut away to visually expose the first pin 404, the second pin 406, and the third pin 408 of the removable barrel plug 400.

As illustrated, the body 402 of the removable barrel plug 400 includes a shaped portion 410 (see FIG. 4E). The shaped portion 410 of the removable barrel plug 400 may be shaped to match a shaped portion of a socket (such as the shaped portion 304 of the socket 300 of FIG. 3A and FIG. 3B). This shaping may cause the removable barrel plug 400 to be received at/in the socket with a correct orientation.

As seen in FIG. 4A and FIG. 4E, the removable barrel plug 400 includes the first pin 404, the second pin 406, and the third pin 408. One or more of these pins 404 through 408 may be received by one or more pin receptacles of a socket of a power adapter. The pins 404 through 408 may be arranged (placed within the removable barrel plug 400) such that they are received at corresponding first pin receptacles of a socket of a power adapter with a correct orientation. For example, the first pin 404, the second pin 406, and the third pin 408 may have been arranged such that they are received at the first pin receptacle 306, the second pin receptacle 308, and the third pin receptacle 310 of the socket 300 (as illustrated in FIG. 3B) with a correct orientation.

The pins 404 through 408 of the removable barrel plug 400 may be made up of electrically conductive material that receives electrical communication of the power at the desired DC voltage that is present from pin receptacles of a socket (such as the socket 300). For example, it may be that the second pin 406 receives the positive connection for the desired DC voltage and the third pin 408 receives the negative connection for the desired DC voltage.

This power may then be communicated to the barrel 412 of the removable barrel plug 400. The barrel 412 may include an electrically conductive outer surface that is electrically connected to a first of the active pins of the removable barrel plug 400 (e.g., one of the second pin 406 and the third pin 408) and an electrically conductive inner surface (that is electrically isolated from the outer surface) that is electrically connected to a second of the active pins of the removable barrel plug 400 (e.g., the other of the second pin 406 and the third pin 408). Thus, the outer surface and the inner surface make up (together) a pair of contacts at the desired DC voltage. Accordingly, when the barrel 412 is inserted into an appropriate barrel receptacle of an output device, power (at the desired DC voltage) is provided to the barrel receptacle of the output device. The output device is thereby enabled to receive and use the power (e.g., for real-time device operation, battery charging, and/or whatever other purpose for receiving power the output device may have).

It is contemplated that many of removable barrel plugs having (different) barrels of varied dimensions may be useable with a (same) socket of a power adapter as disclosed herein. Accordingly, the removable barrel plug 400 may be just one of many possible removable barrel plugs useable with the socket 300. Through swapping or interchanging the removable barrel plugs with the socket 300 as needed, a power adapter is enabled to be operable with a diversity of output devices having differently-sized barrel receptacles.

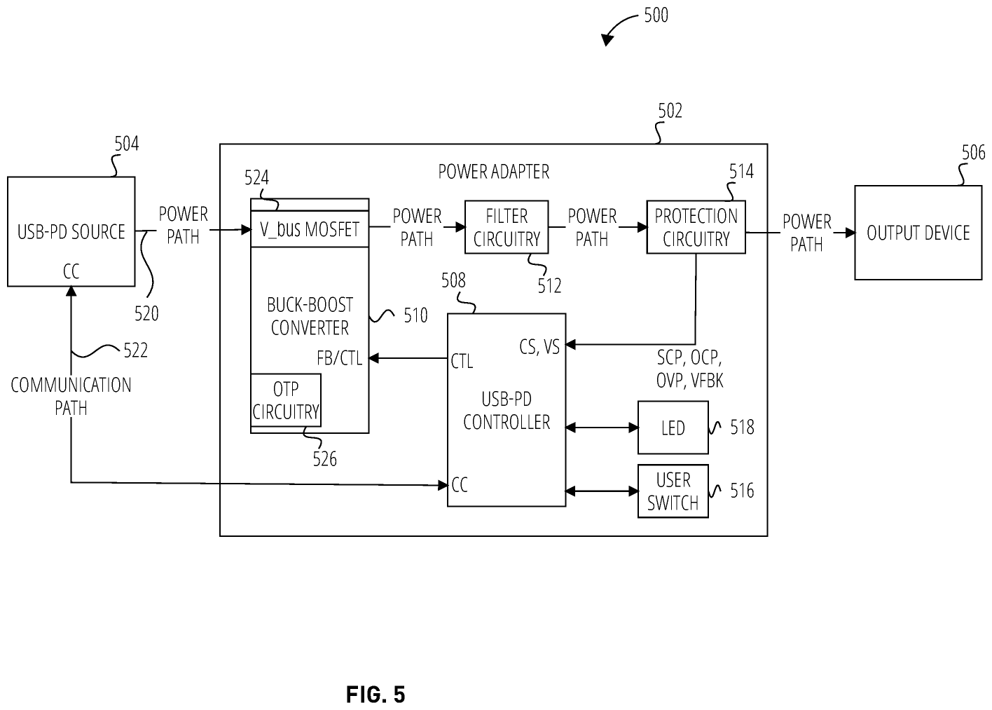

FIG. 5 illustrates a diagram 500 showing the connection between a power adapter 502, a USB-PD source 504, and an output device 506, according to an embodiment. As illustrated, the power adapter 502 includes a USB-PD controller 508, a buck-boost converter 510, filter circuitry 512, protection circuitry 514, a user switch 516, and an LED 518.

The USB-PD source 504 may be hosted by a USB-PD source host device (such as, e.g., the USB-PD source host device 206 described herein).

A power path 520 exists between the USB-PD source 504, the power adapter 502, and the output device 506. This power path 520 facilitates the delivery of power from the USB-PD source 504 to the power adapter 502, through the power adapter 502, and from the power adapter 502 to the output device 506. A first portion of this power path 520 may be established between the USB-PD source 504 and the power adapter 502 via a USB-C cable and USB-C receptacles of the USB-PD source 504 and the power adapter 502, as described herein. This first portion of the power path 520 may be facilitated by one or more V_bus wires of the USB-C cable and one or more corresponding V_bus pins of the USB-C receptacles of each of the USB-PD source 504 and the power adapter 502.

Further, a second portion of this power path 520 may be established between the power adapter 502 and the output device 506 via a socket of the power adapter 502 having an attached removable barrel plug that has been inserted into a barrel receptacle of the output device 506, as described herein.

Additional portion(s) of the power path 520 that are internal to the power adapter 502 (such as leading to, away from, and/or between the buck-boost converter 510, the filter circuitry 512, and the protection circuitry 514) are also illustrated in FIG. 5.

A communication path 522 exists between the USB-PD source 504 and the power adapter 502. This communication path 522 facilitates communications for establishing USB-PD functionality between the USB-PD source 504 and a USB-C receptacle of the power adapter 502 (which operates as a USB-PD sink). This communication path 522 may be established via a USB-C cable and USB receptacles of the USB-PD source 504 and the power adapter 502 (e.g., the same USB-C cable and USB receptacles that establish the first portion of the power path 520). The communication path 522 may be facilitated by a CC wire of the USB-C cable and corresponding CC pins of the USB-C receptacles for each of the USB-PD source 504 and the power adapter 502.

The USB-PD controller 508 of the power adapter 502 is present on the communication path 522 (e.g., via the interfacing with/placement of the CC pin of the power adapter 502 at the USB-PD controller 508, as illustrated). The USB-PD controller 508 may include one or more processors that operate the USB-PD controller 508 by executing computer-readable instructions. Further, the USB-PD controller 508 may include one or more non-transitory computer-readable media that include these instructions.

The USB-PD controller 508 communicates with the USB-PD source 504 along the communication path 522 (e.g., via the CC pins, as described) in order to negotiate a power contract between the USB-PD source 504 and the power adapter 502 (with the power adapter 502 acting as a USB-PD sink). As discussed above, barrel receptacles (such as the barrel receptacle of the output device 506 found along the power path 520) may be used to communicate power according to a pre-assumed or desired DC voltage. Accordingly, the USB-PD controller 508 may negotiate a power contract with the USB-PD source 504 for such a desired DC voltage, such that the USB-PD source 504 provides power at the desired DC voltage to the USB-C receptacle of the power adapter 502 (e.g., for ultimate use at a barrel receptacle interfacing with the output device 506, as described herein).

This desired DC voltage may be defined by a firmware for the power adapter 502 (e.g., stored in a memory of the USB-PD controller 508 and/or that operates on/with the one or more processors of the USB-PD controller 508). It is contemplated that the desired DC voltage may be 5 volts, 9 volts, 12 volts, 15 volts, 20 volts, or any other voltage that may be usefully provided to a barrel receptacle of an output device 506 and that can ultimately be sourced by the USB-PD source 504 using USB-PD methods.

It is contemplated that in some embodiments, the firmware for the power adapter 502 may be changeable to a firmware corresponding to a new desired voltage, such that the USB-PD controller 508 is accordingly reconfigured (by the new firmware) to negotiate a different power contract at a different desired DC voltage.

Once the desired DC voltage is negotiated, the USB-PD controller 508 controls a V_bus MOSFET 524 in (e.g., in the buck-boost converter 510) that is on the power path 520 to close the power path (such that power may flow along the power path through the V_bus MOSFET 524/the buck-boost converter 510). The power at the desired DC voltage is then delivered along the power path 520 through the V_bus MOSFET 524/buck-boost converter 510, the filter circuitry 512, and the protection circuitry 514 to the output device 506.

The buck-boost converter 510 may be used to perform voltage regulation along the power path 520. Such voltage regulation may account for voltage drops along the power path (due to the non-ideal nature of the power path). The buck-boost converter 510 may be configured and/or controlled by the USB-PD controller 508 such that it acts to ensure/keep the voltage on the power path at the negotiated voltage by adjusting the voltage on the power path as necessary.

To facilitate this operation, the USB-PD controller 508 may receive a feedback value regarding the current voltage on the power path 520. This feedback may be received via the labelled VFBK (voltage feedback) communication, which in the illustrated embodiment occurs between the protection circuitry 514 and the USB-PD controller 508. Note that in other non-illustrated embodiments (e.g., embodiments not including the protection circuitry 514), the USB-PD controller 508 may be configured to take a voltage reading directly from the power path 520.

The behavior of the buck-boost converter 510 is then controlled by communications from the CTL (control) pin of the USB-PD controller 508 to the FB/CTL (feedback/control) pin on the buck-boost converter 510. Such communications may provide feedback to the buck-boost converter 510 regarding the voltage or voltage error on the power path, and/or may more correspond to direct commands for the buck-boost converter 510 as determined by the USB-PD controller 508 in view of the voltage error on the power path 520 as calculated by the USB-PD controller 508. The buck-boost converter 510 may then use this information (in either case) to adjust the voltage on the power path 520 such that it remains/is kept at the negotiated voltage (e.g., within an acceptable range of error, such as +/−5%).

The buck-boost converter 510 may include an overtemperature protection (OTP) module 526. The OTP circuitry 526 may check that the temperature at the power adapter 502 is not above (or is at or above) a threshold (e.g., that is set to protect the functional integrity of the power adapter 502 and/or the environment in which the power adapter 502 operates). In the case that the temperature at the power adapter 502 rises above (or is at or above) the threshold, the OTP circuitry 526 may operate to open the power path 520 by toggling the V_bus MOSFET 524 (e.g., until such a time as the temperature at the power adapter 502 is back within acceptable levels or needs power cycling).

In some embodiments, the Filter Circuitry 512, Protection Circuitry 514, power switch V_bus MOSFET 524, and User Switch 516 may not be present. In such cases, the USB-PD controller 508 may interface directly with the USB PD source charger 504 via CC pin Communication Path 522 and Power Path 520, to establish the desired output voltage preset in the USB-PD controller 508 firmware.

The buck-boost converter 510 may not be present in some embodiments. In such cases, the V_bus MOSFET 524 may instead be stand-alone (e.g., not part of the buck-boost converter 510). In such cases, the USB-PD controller 508 may interface directly with a (stand-alone) V_bus MOSFET 524 (via the CTL pin of the USB-PD controller 508) to control whether the power path 520 is open or closed during protection mode supported by Protection Circuitry 514 or controlled by User Switch 516. The USB-PD controller 508 would then draw housekeeping power directly from USB-PD source 504 via Power Path 520, as described herein.

From the buck-boost converter 510/V_bus MOSFET 524, the power may then proceed through the filter circuitry 512. The filter circuitry 512 may filter the power to remove undesirable noise. The filter circuitry 512 may not be used/present in some embodiments.

The power may then proceed through the protection circuitry 514. The protection circuitry 514 may act to protect the power adapter 502 from any overcurrent condition (via the labelled OCP (overcurrent protection) communication between the protection circuitry 514 and the USB-PD controller 508) and/or overvoltage condition (via the labelled OVP (overvoltage protection) communication between the protection circuitry 514 and the USB-PD controller 508) and/or any short circuit condition (via the labelled SCP (short circuit protection) communication between the protection circuitry 514 and the USB-PD controller 508) that may occur within the transported power by communicating with the USB-PD controller 508 whenever such a condition is detected at the protection circuitry 514. As illustrated, these communications may be received on a CS, VS (current sense, voltage sense) pin on the USB-PD controller 508. In such cases, the USB-PD controller 508 may, in response, control the V_bus MOSFET 524 to open the power path 520 (via communications from the CTL pin of the USB-PD controller 508 to the FB/CTL pin of the buck-boost converter 510, or directly in embodiments without the buck-boost converter 510), such that the power flow along the power path 520 is halted.

In some embodiments, the USB-PD controller 508 may be configured take a voltage reading and/or a current reading directly from the power path 520 (via the CS, VS pin on the USB-PD controller 508). This may be useful for feedback and/or for checking for overvoltage/overcurrent/short circuit conditions at the USB-PD controller 508. In some instances, such direct measurement and analysis capabilities may be used at the USB-PD controller 508 in embodiments where there is no dedicated protection circuitry 514 to provide overvoltage/overcurrent/short circuit protection-related communications to the USB-PD controller 508.

The power (at the desired DC voltage) is then delivered from the protection circuitry 514 to a socket of the power adapter 502, where it is accessible at the output device 506 via the interaction of a removable barrel plug with both the socket of the power adapter 502 and a barrel receptacle of the output device 506, in the manner described herein.

The power adapter 502 also includes, in some embodiments, a user switch 516. The user switch 516 may be a physical switch (such as the user switch 112 of FIG. 1 and FIG. 2) that enables a user to activate and/or deactivate the power adapter 502 (e.g., activate or deactivate the delivery of power along the power path 520 through the power adapter 502). The user switch 516 may report its state to the USB-PD controller 508, which may accordingly activate or deactivate the flow of power along the power path 520 through the power adapter 502 by controlling the V_bus MOSFET 524 to open the power path (e.g., via communications from the CTL pin of the USB-PD controller 508 to the FB/CTL pin of the buck-boost converter 510, or directly in embodiments where there is no buck-boost converter 510) when the user switch 516 indicates that the flow of power through the power adapter 502 should be deactivated. Accordingly, the user is enabled to interrupt power delivery through the power adapter 502 to the socket of the power adapter 502.

The power adapter 502 also includes, in some embodiments, an LED 518. The LED 518 may be controlled by the USB-PD controller 508 to match the state of the V_bus MOSFET 524 when the power adapter 502 is connected to the USB-PD Source 504, such that a user may be aware of whether the power path 520 is currently closed or open/whether power is currently being transported along the power path 520 through the power adapter 502.

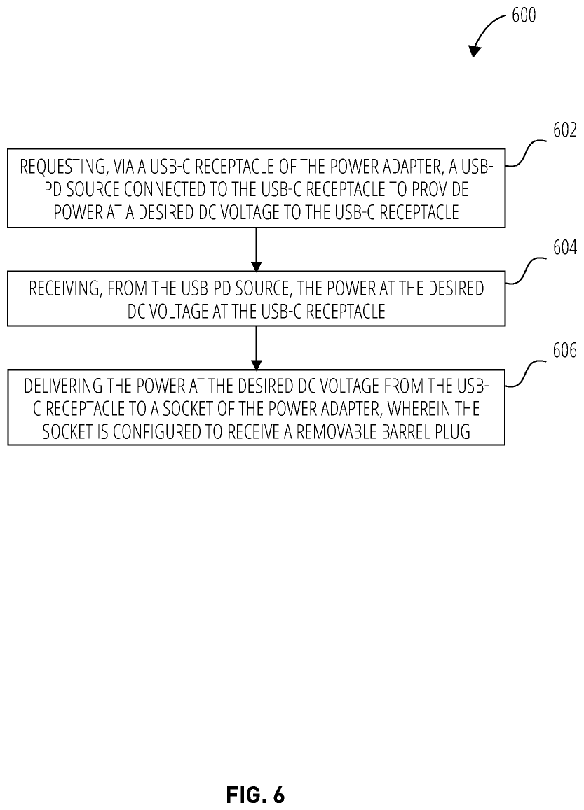

FIG. 6 illustrates a method 600 of a power adapter, according to an embodiment. The method 600 includes requesting 602, via a USB-C receptacle of the power adapter, a USB-PD source connected to the USB-C receptacle to provide power at a desired DC voltage to the USB-C receptacle.

The method 600 further includes receiving 604, from the USB-PD source, the power at the desired DC voltage at the USB-C receptacle.

The method 600 further includes delivering 606 the power at the desired DC voltage from the USB-C receptacle to a socket of the power adapter, wherein the socket is configured to receive a removable barrel plug.

In some embodiments, the method 600 further includes keeping the power at the desired DC voltage using buck-boost circuitry.

In some embodiments of the method 600, the desired DC voltage is 20 volts.

In some embodiments of the method 600, the desired DC voltage is 9 volts.

In some embodiments of the method 600, the desired DC voltage is 5 volts.

In some embodiments of the method 600, the desired DC voltage is 12 volts.

In some embodiments of the method 600, the desired DC voltage is 15 volts.

In some embodiments, the method 600 further includes determining the desired DC voltage based on a firmware for the power adapter.

In some embodiments, the method 600 further includes filtering the power prior to delivering the power to the socket.

In some embodiments of the method 600, the socket is configured to receive one or more pins of the removable barrel plug.

In Some Embodiments of the Method 600, the Socket is Shaped Such that it Receives the Removable Barrel Plug with a Correct Orientation.

In some embodiments of the method 600, pin receptacles of the socket are arranged to receive pins of the removable barrel plug with a correct orientation.

In some embodiments, the method 600 further comprises using filtering circuitry to filter the power prior to delivery of the power at the socket.

In some embodiments, the method 600 further comprises using protection circuitry to protect the power adapter from one of overcurrent, overvoltage, and a short circuit.

In some embodiments, the method 600 further comprises using OTP circuitry to keep a temperature at the power adapter within acceptable levels.

In some embodiments, the method 600 further comprises using a user-adjustable switch to interrupt delivery of the power to the socket.

In some embodiments, the method 600 further comprises operating an LED of the power adapter corresponding to the delivery of the power at the desired DC voltage from the USB-C receptacle to the socket of the power adapter.

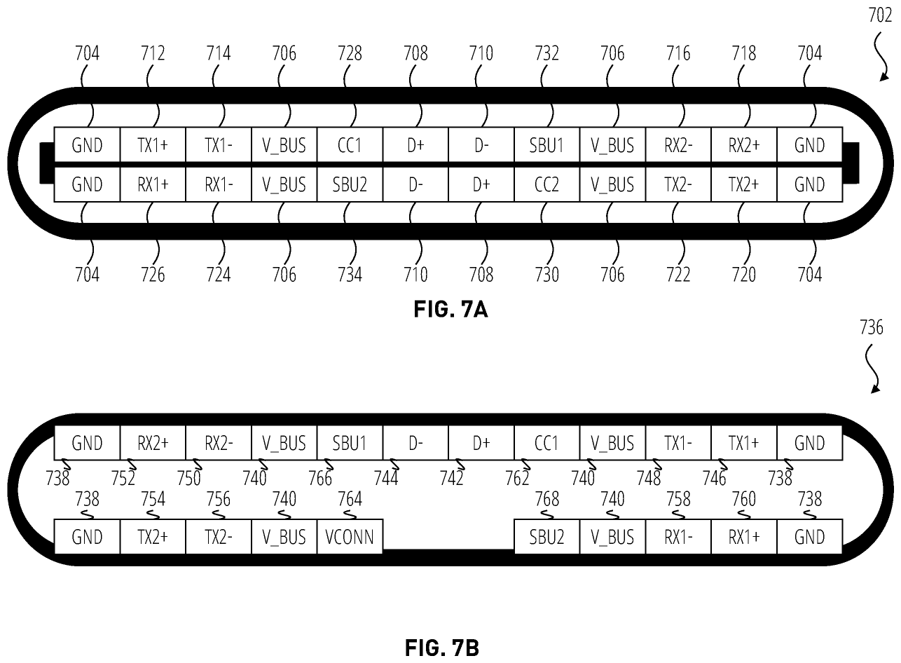

FIG. 7A illustrates a pinout of a USB-C receptacle 702, according to an embodiment. The USB-C receptacle 702 may be as found on a device such as a power adapter (e.g., as part of a USB-PD sink of the power adapter) and/or as part of a USB-PD source.

The USB-C receptacle 702 includes the GND pins 704 and the V_bus pins 706 in the illustrated locations. The GND pins 704 and the V_bus pins 706 may be for the transport of power through the USB-C receptacle 702 (e.g., in the form of a current passing through the USB-C receptacle 702 as facilitated by a DC voltage between the GND pins 704 and the V_bus pins 706 of the USB-C connector). In some embodiments, this power defaults to 5 volts DC at either 1.5 amps or 3 amps.

In embodiments involving connections between USB-PD sources and sinks, this power may be according to a power contract negotiated via the USB-C receptacle 702 between a USB-PD source and a USB-PD sink. In such cases, the voltage may be higher than 5 volts (e.g., 9 volts, 12 volts, 15 volts, 20 volts, or some other voltage requested by the USB-PD sink) and the amperage may be higher than 3 amps (e.g., 5 amps, or some other amperage requested by the USB-PD sink).

The USB-C receptacle 702 further includes the D+ pins 708 and the D− pins 710. The D+ pins 708 may act as a differential signaling pair with the D− pins 710 to provide data signaling through the USB-C receptacle 702 (e.g., at USB 2.0 speeds). Note that the D+ pins 708 and the D− pins 710 are redundant pins for the same wires/traces as correspondingly used by the D+ pins 708 and the D− pins 710, and are provided in the illustrated manner to support reversibility of any USB-C plug inserted into the USB-C receptacle 702.

The USB-C receptacle 702 further includes the TX1+ pin 712 and the TX1− pin 714, the RX2− pin 716 and the RX2+ pin 718, the TX2+ pin 720 and the TX2− pin 722, and the RX1− pin 724 and the RX1+ pin 726. These pins represent four additional differential pairs that may pass through the USB-C receptacle 702. In some embodiments, one or more of these differential pairs are used for data transfer (e.g., in addition to the differential pair represented by the D+ pins 708 and the D− pins 710) to achieve faster data throughput (e.g., at USB 3.0/USB 3.1 speeds).

The USB-C receptacle 702 further includes the CC1 pin 728 and the CC2 pin 730. These pins are provided such that a CC wire of a USB-C cable that is configured for USB-PD use can facilitate the communications between a USB-PD source and a USB-PD sink (e.g., in order to negotiate a power contract between the USB-PD source and the USB-PD sink) using one of the CC1 pin 728 and the CC2 pin 730 (two are provided in the USB-C receptacle 702 to support the reversibility of the USB-C plug of such a USB-C cable).

The SBU1 pin 732 and the SBU2 pin 734 may be enabled when the USB-C receptacle 702 is used in an Alternate Mode.

FIG. 7B illustrates a pinout of a USB-C plug 736, according to an embodiment. The USB-C receptacle USB-C plug 736 may be as found on a USB-C cable.

The USB-C plug 736 includes the GND pins 738, V_bus pins 740, a D+ pin 742 and a D− pin 744, a TX1+ pin 746 and a TX1− pin 748, an RX2− pin 750 and an RX2+ pin 752, a TX2+ pin 754 and a TX2− pin 756, an RX1− pin 758 and an RX1+ pin 760, a CC1 pin 762, an SBU1 pin 766, and an SBU2 pin 768 that are each analogous to pins of the same name from the USB-C receptacle 702 as described herein.

It is noted that if the USB-C plug 736 is reversed, the particular pairings of the D+ pin 742 and the D− pin 744 with a respective pair of the D+ pins 708 and the D− pins 710 of the USB-C receptacle 702 may be changed. Further, it is noted that if the USB-C plug 736 is reversed, the particular pairings of remaining differential pairs (TX1+ pin 746 and TX1− pin 748, RX2− pin 750 and RX2+ pin 752, TX2+ pin 754 and TX2− pin 756, and RX1− pin 758 and RX1+ pin 760) may contact remaining differential pairs (TX1+ pin 712 and TX1− pin 714, RX2− pin 716 and RX2+ pin 718, TX2+ pin 720 and TX2− pin 722, and RX1− pin 724 and RX1+ pin 726) of a different name of the USB-C receptacle 702. This is just a mismatch in happenstance labelling, and would not change the overall ability to use the pairings of differential pairs for data transfer.

A wire using the USB-C plug 736 may use only a single CC wire (attached to the CC1 pin 762 of the USB-C plug 736) for communication. By testing for a connection with another device through this wire, a USB-PD source or sink using the USB-C receptacle 702 that is connected to the USB-C plug 736 may determine whether the CC1 pin 728 or the CC2 pin 730 of the USB-C receptacle 702 can be used as a communication path with the another USB-PD source/sink (e.g., such that a power contract between the USB-PD source and USB-PD sink can be negotiated on the CC wire of the USB-C cable).

Further, it follows that the VCONN pin 764 of the USB-C plug 736 will accordingly be connected to the other of the CC1 pin 728 and the CC2 pin 730 of the USB-C receptacle 702. This connection may allow the device having the USB-C receptacle 702 to provide the USB-C cable of the USB-C plug 736 with sufficient voltage to power an integrated circuit of the USB-C cable (if the USB-C cable is “electronically marked”) such that it can communicate with the device of the USB-C receptacle 702 (e.g., to report on the capabilities of the USB-C cable to the device).

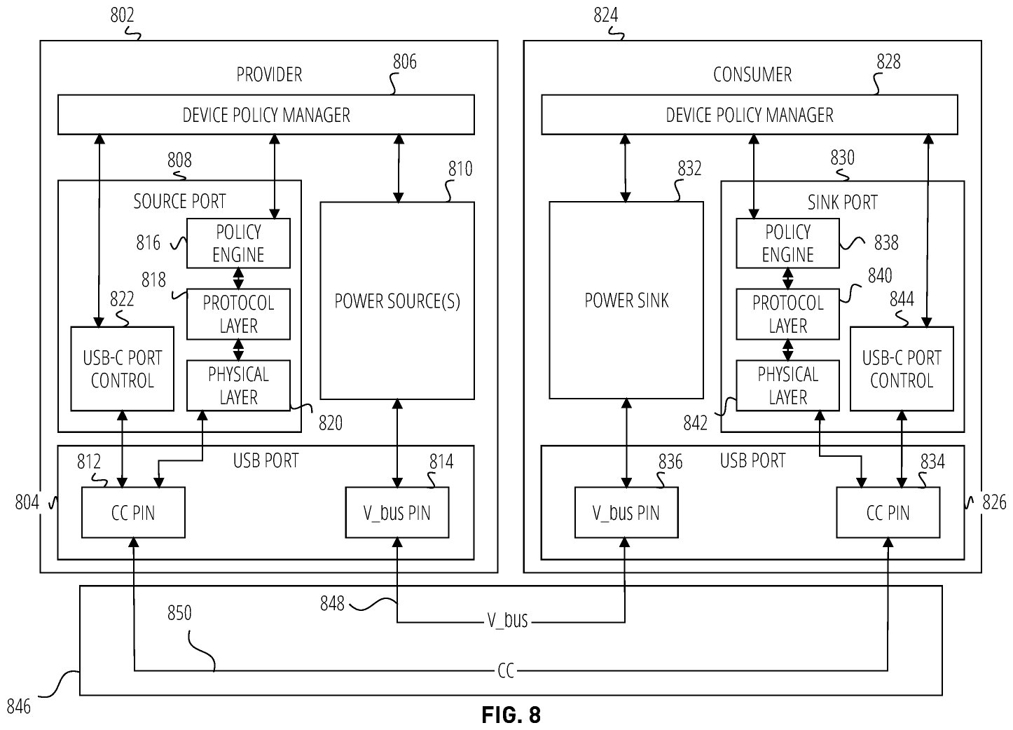

FIG. 8 illustrates a logical architecture of a provider 802 and a consumer 824 in a USB-PD relationship, according to an embodiment.

The provider 802 may include a USB port 804, a device policy manager 806, a source port 808, and a power source(s) 810. The provider 802 may be generally understood to correspond to the use of a USB-PD source as described herein.

The provider 802 connects to the consumer 824 through the USB port 804 of the provider 802 by a USB-C cable 846 having (e.g., inter alia) a V_bus wire 848 and a CC wire 850. A CC pin 812 of the USB port 804 handles signaling between the provider 802 and the consumer 824 (along a CC wire 850 of the USB-C cable 846), and a V_bus pin 814 enables power transport from the provider 802 to the consumer 824 (along the (one or more) V_bus wire 848 (and an unillustrated (one or more) GND wire of the USB-C cable 846)).

The device policy manager 806 may control USB-PD aspects for a host device of the provider 802 (e.g., across multiple USB-PD ports of the host device, should multiple exist). The USB port 804, the source port 808, and the power source(s) 810 together operate as configured by the device policy manager 806.

The source port 808 includes a policy engine 816, a protocol layer 818, a physical layer 820, and a USB-C port control 822. The policy engine 816 is responsible for implementing the configuration from the protocol layer 818 for this (individual) USB-PD source of the device to trigger communications that are to be sent/received to/from the consumer 824. The protocol layer 818 handles the generation, encapsulation, and/or de-encapsulation of these communications, and the physical layer 820 handles physical layer signaling as between the provider 802 and the device policy manager 806.

The USB-C port control 822 is responsible for, for example, the detection and handling of connection/disconnection events (e.g., the connection/disconnection of the USB-C cable 846 with the USB port 804 of the provider 802) and communicating these back to the device policy manager 806.

The physical layer 820 interacts with the CC pin 812 of the USB port 804 to send/receive signaling to/from the consumer 824 on the CC wire 850 of the USB-C cable 846. Further, the USB-C port control 822 uses the CC pin 812 to, for example, detect any connection/disconnection of the USB-C cable 846.

The device policy manager 806 operates the power source(s) 810 corresponding to communications that occur between the provider 802 and the consumer 824 (as routed with the device policy manager 806 through the CC pin 812 of the USB port 804 and the policy engine 816, protocol layer 818, and physical layer 820 of the source port 808 in the manner described herein). The power source(s) 810 may be used to provide power to the consumer 824 (e.g., using the (one or more) V_bus wire 848 of the USB-C cable 846 and any (one or more) GND wire of the USB-C cable 846 (unillustrated)) according to a power contract negotiated between the provider 802 and the consumer 824 (e.g., that was negotiated using the CC wire 850 of the USB-C cable 846).

The consumer 824 may include a USB port 826, a device policy manager 828, a sink port 830, and a power sink 832. The consumer 824 may be generally understood to correspond to the use of a USB-PD sink as described herein.

A CC pin 834 of the USB port 826 handles signaling between the consumer 824 and the provider 802 (along the CC wire 850 of the USB-C cable 846), and a V_bus pin 836 of the USB port 826 enables power receipt from the provider 802 at the consumer 824 (along the (one or more) V_bus wire 848 (and an unillustrated (one or more) GND wire of the USB-C cable 846)).

The device policy manager 828 may control USB-PD aspects for a host device of the consumer 824 (e.g., across multiple USB-PD ports of the host device, should multiple exist). The USB port 826, the sink port 830, and the power sink 832 together operate as configured by the device policy manager 828.

The sink port 830 includes a policy engine 838, a protocol layer 840, a physical layer 842, and a USB-C port control 844. These perform analogous features for the sink port 830 of the consumer 824 as those respectively performed by the policy engine 816, the protocol layer 818, the physical layer 820, and the USB-C port control 822 of the source port 808 of the provider 802.

The power sink 832 may consume the power sourced from the provider 802 (e.g., using the (one or more) V_bus wire 848 of the USB-C cable 846 and any (one or more) GND wire of the USB-C cable 846 (unillustrated)) according to a power contract negotiated between the provider 802 and the consumer 824 (e.g., that was negotiated using the CC wire 850 of the USB-C cable 846).

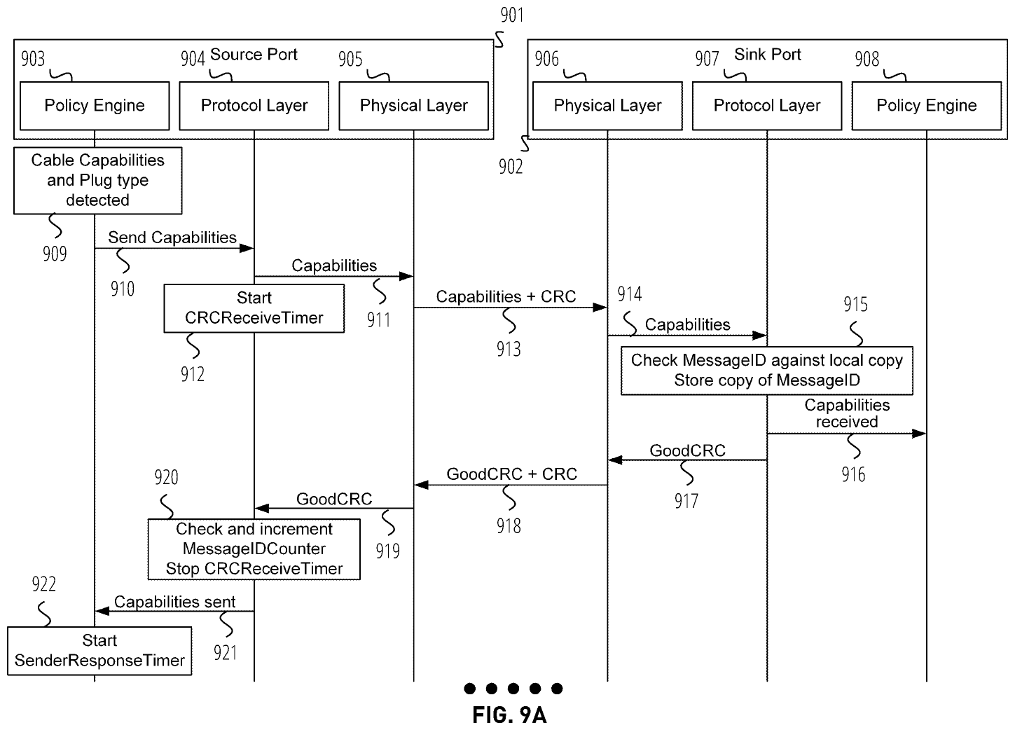

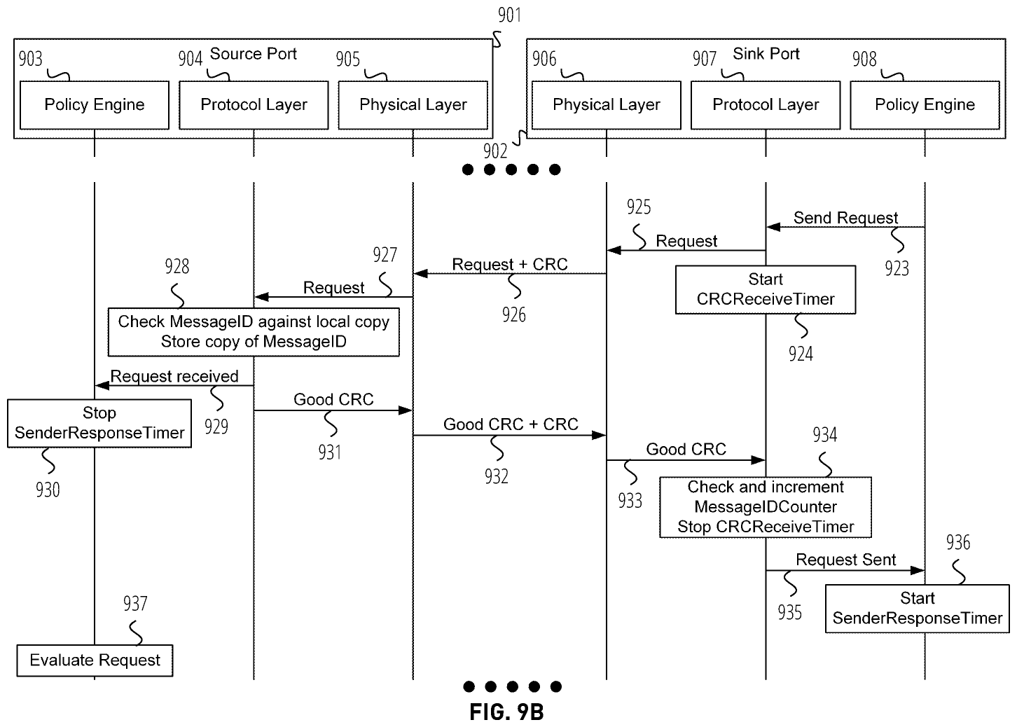

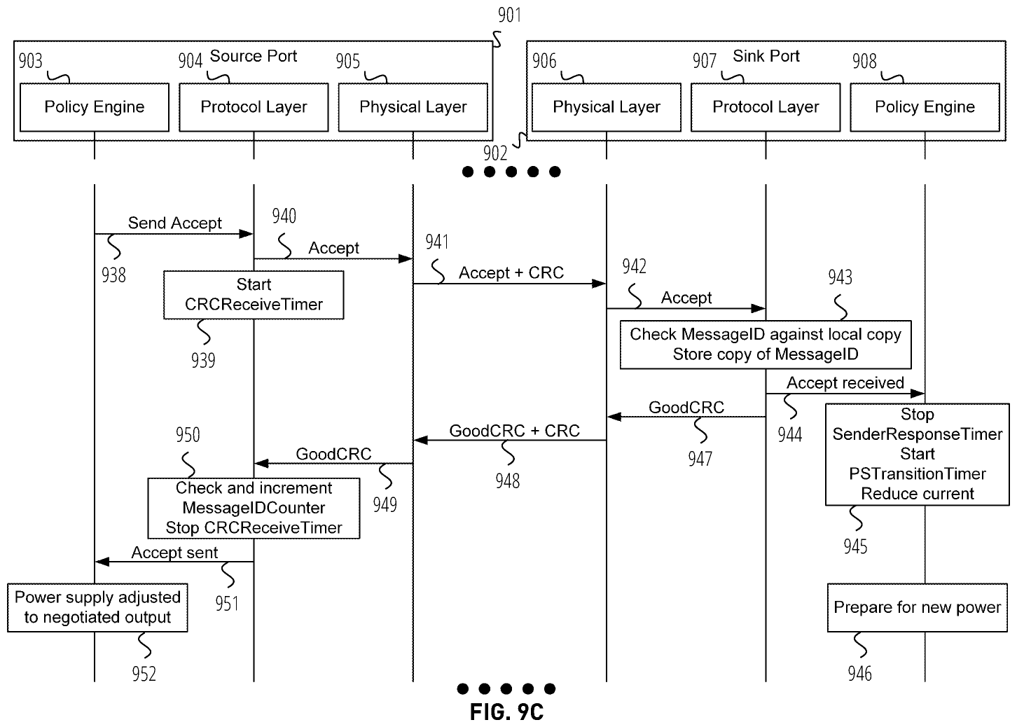

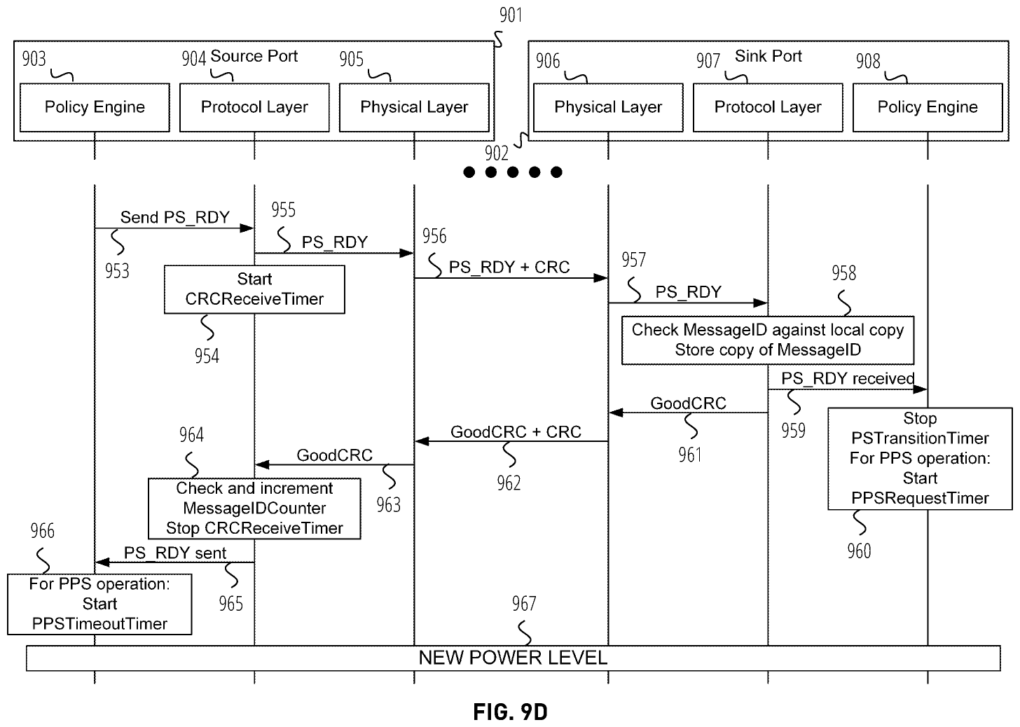

FIG. 9A, FIG. 9B, FIG. 9C, and FIG. 9D together illustrate a flow diagram for establishing a power contract between a USB-PD source 901 and a USB-PD sink 902 when using Standard Power Range (SPR), according to an embodiment.

The source policy engine 903 first determines 909 cable capabilities and plug type of any attached cable (e.g., a USB-C cable), if these are not already known at the USB-PD source 901.

The source policy engine 903 then instructs 910 the source protocol layer 904 to send a Source Capabilities message detailing the power source capabilities of the USB-PD source 901 to the USB-PD sink 902.

The source protocol layer 904 generates the Source Capabilities message and sends 911 the Source_Capabilities message to the source physical layer 905. The source protocol layer 904 also starts 912 a CRCReceiveTimer.

The source physical layer 905 appends a cyclic redundancy check (CRC) to the Source_Capabilities message and sends 913 the Source_Capabilities message to the sink physical layer 906. Note that communications between the source physical layer 905 and the sink physical layer 906 are physically performed across, for example, respective CC pins of the USB-PD source 901 and the USB-PD sink 902 and a CC wire of the USB-C cable.

The sink physical layer 906 verifies the CRC of the Source_Capabilities message, and then sends 914 the Source_Capabilities message to the sink protocol layer 907.

The sink protocol layer 907 checks 915 the MessageID of the Source_Capabilities message against a local copy (e.g., to make sure it is an expected next MessageID) and then stores a copy of this MessageID for future reference. The sink protocol layer 907 then provides 916 the Source_Capabilities message to the sink policy engine 908. Further, the sink protocol layer 907 generates a GoodCRC message for the USB-PD source 901 (for acknowledging the receipt of the Source_Capabilities message) and then sends 917 the GoodCRC message to the sink physical layer 906.

The sink physical layer 906 appends a CRC to the GoodCRC message and sends 918 the GoodCRC message to the source physical layer 905.

The source physical layer 905 verifies the CRC of the GoodCRC message, and then sends 919 the GoodCRC message to the source protocol layer 904.

The source protocol layer 904 checks 920 that the GoodCRC message reports that a correct MessageID was used, and then increments the MessageIDCounter used by the USB-PD source 901 to generate MessageIDs. The source protocol layer 904 also stops the previously started CRCReceiveTimer. The source protocol layer 904 further informs 921 that the Source_Capabilities message was successfully sent to the USB-PD sink 902.

In response, the USB-PD source 901 starts 922 a SenderResponseTimer.

After analyzing the Source_Capabilities message, the sink policy engine 908 instructs 923 the sink protocol layer 907 to send a Request message configured to inform the USB-PD source 901 of the power level it would like to select (e.g., according to the options represented in the Source_Capabilities message).

The sink protocol layer 907 generates the Request message and sends 925 the Request message to the sink physical layer 906. Further, the sink protocol layer 907 starts 924 a corresponding CRCReceiveTimer.

The sink physical layer 906 appends a CRC to the Request message, and then sends 926 the Request message to the source physical layer 905.

The source physical layer 905 verifies the CRC of the Request message, and then sends 927 the Request message to the source protocol layer 904.

The source protocol layer 904 checks 928 the MessageID of the Request message against a local copy (e.g., to make sure it is an expected next MessageID) and then stores a copy of this MessageID for future reference. The source protocol layer 904 then provides 929 the Request message to the source policy engine 903. Further, the source protocol layer 904 generates a GoodCRC message for the USB-PD sink 902 (for acknowledging the receipt of the Request message) and the sends 931 the GoodCRC message to the source physical layer 905.

Upon receiving the Request message, the source policy engine 903 stops 930 its previously started SenderResponseTimer.

The source physical layer 905 appends a CRC to the GoodCRC message and sends 932 the GoodCRC message to the sink physical layer 906.

The sink physical layer 906 verifies the CRC of the GoodCRC message, and then sends 933 the GoodCRC message to the sink protocol layer 907.

The sink protocol layer 907 checks 934 that the GoodCRC message reports that a correct MessageID was used, and then increments the MessageIDCounter used by the USB-PD sink 902 to generate MessageIDs. The sink protocol layer 907 also stops the previously started CRCReceiveTimer. The sink protocol layer 907 further informs 935 the sink policy engine 908 that the Request message was successfully sent to the USB-PD source 901.

In response, the sink policy engine 908 starts 936 a SenderResponseTimer.

The source policy engine 903 evaluates 937 the Request message to identify the power level requested by the USB-PD sink 902.

Upon determining that it can provide the power level represented in the Request message, the source policy engine 903 instructs 938 the source protocol layer 904 to send an Accept message to the USB-PD sink 902.

The source protocol layer 904 generates the Accept message and sends 940 the Accept message to the source physical layer 905. Further, the source protocol layer 904 starts 939 a corresponding CRCReceiveTimer.

The source physical layer 905 appends a CRC to the Accept message, and then sends 941 the Accept message to the sink physical layer 906.

The sink physical layer 906 verifies the CRC of the Accept message, and then sends 942 the Accept message to the sink protocol layer 907.

The sink protocol layer 907 checks 943 the MessageID of the Accept message against the local copy (e.g., to make sure it is an expected next MessageID) and then stores a copy of this MessageID for future reference. The sink protocol layer 907 then informs 944 the sink policy engine 908 that the Accept message has been received. Further, the sink protocol layer 907 generates a GoodCRC message for the USB-PD source 901 (for acknowledging the receipt of the Accept message) and then sends 947 the GoodCRC message to the sink physical layer 906.

Upon being informed of the receipt of the Accept message, the sink policy engine 908 stops 945 its previously started SenderResponseTimer. The sink policy engine 908 further starts a PSTransitionTimer. The sink policy engine 908 also reduces the current draw of the USB-PD sink 902. The sink policy engine 908 further prepares 946 for a new power level that is to be provided by the USB-PD source 901.

The sink physical layer 906 appends a CRC to the GoodCRC message and sends 948 the GoodCRC message to the source physical layer 905.

The source physical layer 905 verifies the CRC of the GoodCRC message, and then sends 949 the GoodCRC message to the source protocol layer 904.

The source protocol layer 904 checks 950 that the GoodCRC message reports that a correct MessageID was used, and then increments the MessageIDCounter used by the USB-PD source 901 to generate MessageIDs. The source protocol layer 904 also stops the previously started CRCReceiveTimer. The source protocol layer 904 further informs 951 the source policy engine 903 that the Accept message was successfully sent to the USB-PD sink 902.

The source policy engine 903 further adjusts 952 the power supply of the USB-PD source 901 to match the negotiated power level.

The source policy engine 903 then instructs 953 the source protocol layer 904 to send a PS_RDY message to the USB-PD sink 902.

The source protocol layer 904 generates the PS_RDY message and sends 955 the PS_RDY message to the source physical layer 905. Further, the source protocol layer 904 starts 954 a corresponding CRCReceiveTimer.

The source physical layer 905 appends a CRC to the PS_RDY message, and then sends 956 the PS_RDY message to the sink physical layer 906.

The sink physical layer 906 verifies the CRC of the PS_RDY message, and then sends 957 the PS_RDY message to the sink protocol layer 907.

The sink protocol layer 907 checks 958 the MessageID of the PS_RDY message against the local copy (e.g., to make sure it is an expected next MessageID) and then stores a copy of this MessageID for future reference. The sink protocol layer 907 then informs 959 the sink policy engine 908 that the PS_RDY message has been received. Further, the sink protocol layer 907 generates a GoodCRC message for the USB-PD source 901 (for acknowledging the receipt of the PS_RDY message) and then sends 961 the GoodCRC message to the sink physical layer 906.

Upon being informed of the receipt of the PS_RDY message, the sink policy engine 908 stops 960 its previously started PSTransitionTimer. If the negotiated power is according to Programmable Power Supply (PPS) operation between the USB-PD source 901 and the USB-PD sink 902, the sink policy engine 908 also starts a PPSRequestTimer.

The sink physical layer 906 appends a CRC to the GoodCRC message and sends 962 the GoodCRC message to the source physical layer 905.

The source physical layer 905 verifies the CRC of the GoodCRC message, and then sends 963 the GoodCRC message to the source protocol layer 904.

The source protocol layer 904 checks 964 that the GoodCRC message reports that a correct MessageID was used, and then increments the MessageIDCounter used by the USB-PD source 901 to generate MessageIDs. The source protocol layer 904 also stops the previously started CRCReceiveTimer. The source protocol layer 904 further informs 965 the source policy engine 903 that the PS_RDY message was successfully sent to the USB-PD sink 902.

If the negotiated power is according to PPS operation between the USB-PD source 901 and the USB-PD sink 902, the source policy engine 903 starts 966 a PPSTimeoutTimer (or SourcePPSCommTimer).

The transfer of power from the USB-PD source 901 to the USB-PD sink 902 then proceeds according to the new power level 967 of the power contract that has been negotiated.

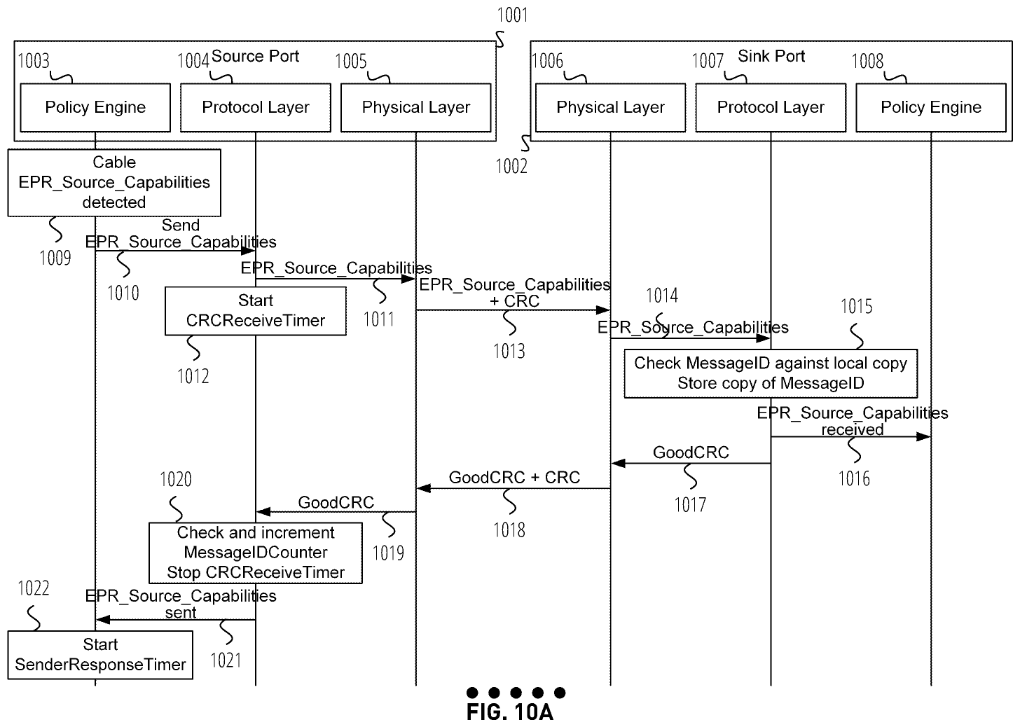

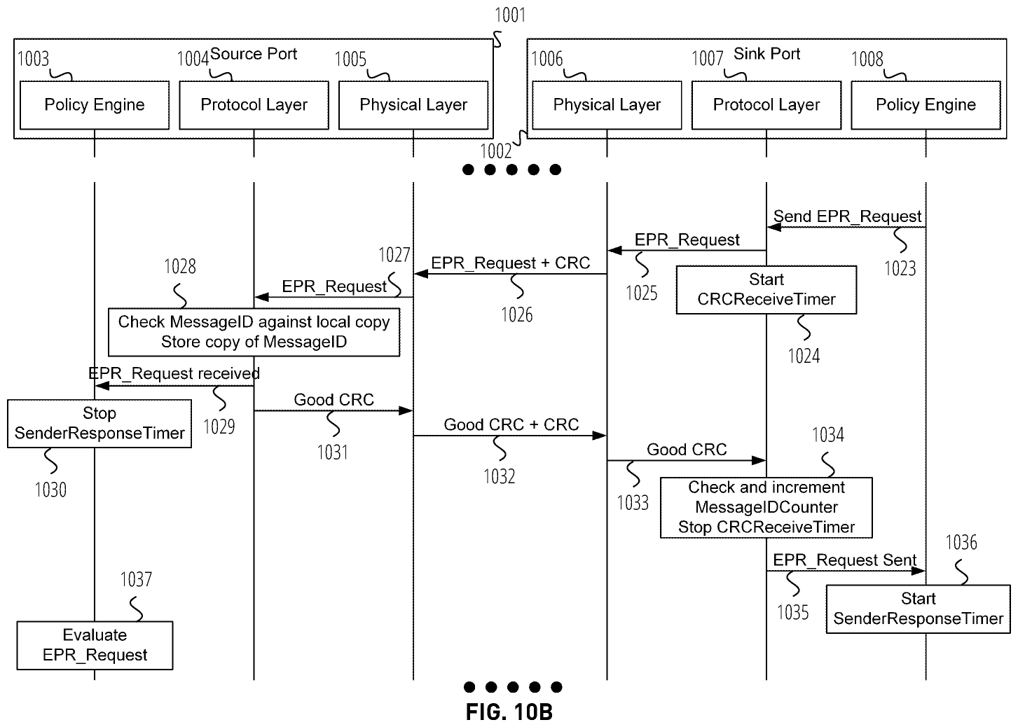

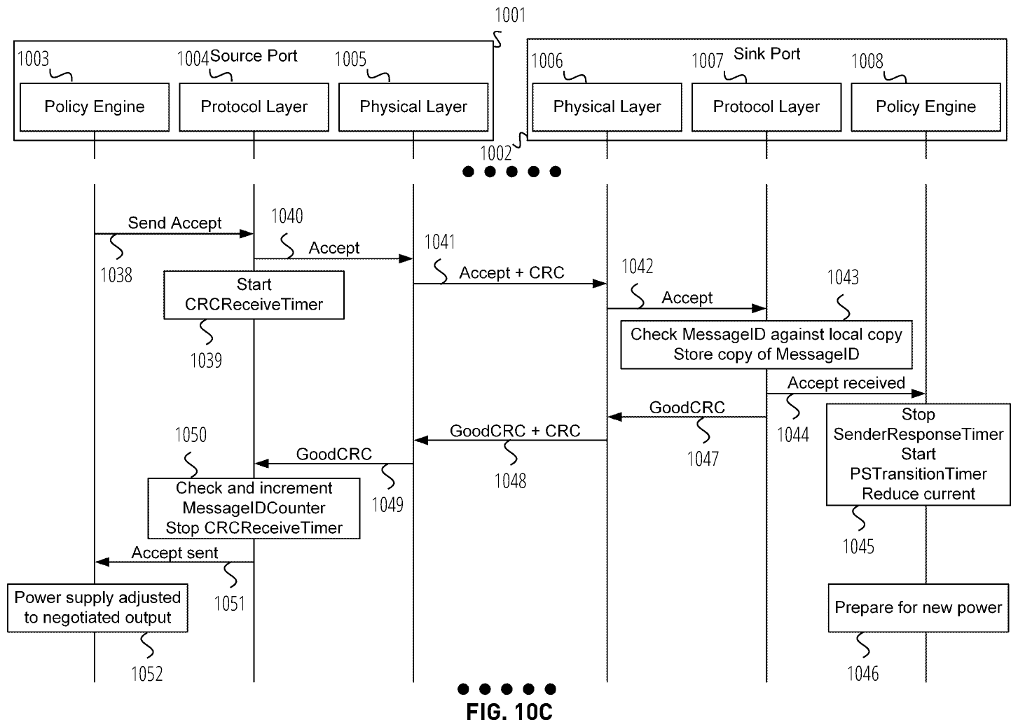

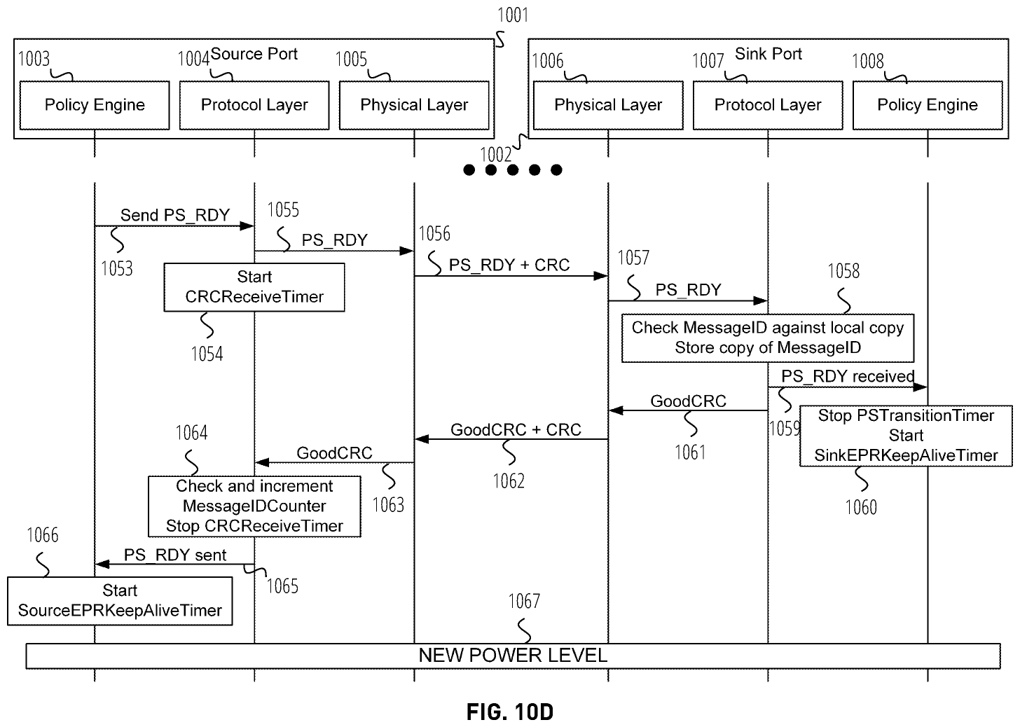

FIG. 10A, FIG. 10B, FIG. 10C, and FIG. 10D together illustrate a flow diagram for establishing a power contract between a USB-PD source and a USB-PD sink when using Extended Power Range (EPR), according to an embodiment.

The source policy engine 1003 first determines 1009 cable capabilities and plug type of any attached cable (e.g., a USB-C cable), if these are not already known at the USB-PD source 1001.

The source policy engine 1003 then instructs 1010 the source protocol layer 1004 to send an EPR_Source_Capabilities message detailing the power source capabilities of the USB-PD source 1001 to the USB-PD sink 1002.

The source protocol layer 1004 generates the EPR_Source_Capabilities message and sends 1011 the EPR_Source_Capabilities message to the source physical layer 1005. The source protocol layer 1004 also starts 1012 a CRCReceiveTimer.

The source physical layer 1005 appends a CRC to the EPR_Source_Capabilities message and sends 1013 the EPR_Source_Capabilities message to the sink physical layer 1006. Note that communications between the source physical layer 1005 and the sink physical layer 1006 are physically performed across, for example, respective CC pins of the USB-PD source 1001 and the USB-PD sink 1002 and a CC wire of the USB-C cable.

The sink physical layer 1006 verifies the CRC of the EPR_Source_Capabilities message, and then sends 1014 the EPR_Source_Capabilities message to the sink protocol layer 1007.

The sink protocol layer 1007 checks 1015 the MessageID of the EPR_Source_Capabilities message against a local copy (e.g., to make sure it is an expected next MessageID) and then stores a copy of this MessageID for future reference. The sink protocol layer 1007 then provides 1016 the EPR_Source_Capabilities message to the sink policy engine 1008. Further, the sink protocol layer 1007 generates a GoodCRC message for the USB-PD source 1001 (for acknowledging the receipt of the EPR_Source_Capabilities message) and then sends 1017 the GoodCRC message to the sink physical layer 1006.

The sink physical layer 1006 appends a CRC to the GoodCRC message and sends 1018 the GoodCRC message to the source physical layer 1005.

The source physical layer 1005 verifies the CRC of the GoodCRC message, and then sends 1019 the GoodCRC message to the source protocol layer 1004.

The source protocol layer 1004 checks 1020 that the GoodCRC message reports that a correct MessageID was used, and then increments the MessageIDCounter used by the USB-PD source 1001 to generate MessageIDs. The source protocol layer 1004 also stops the previously started CRCReceiveTimer. The source protocol layer 1004 further informs 1021 that the EPR_Source_Capabilities message was successfully sent to the USB-PD sink 1002.

In response, the USB-PD source 1001 starts 1022 a SenderResponseTimer.

After analyzing the EPR_Source_Capabilities message, the sink policy engine 1008 instructs 1023 the sink protocol layer 1007 to send an EPR_Request message configured to inform the USB-PD source 1001 of the power level it would like to select (e.g., according to the options represented in the EPR_Source_Capabilities message).

The sink protocol layer 1007 generates the Request message and sends 1025 the EPR_Request message to the sink physical layer 1006. Further, the sink protocol layer 1007 starts 1024 a corresponding CRCReceiveTimer.

The sink physical layer 1006 appends a CRC to the EPR_Request message, and then sends 1026 the EPR_Request message to the source physical layer 1005.

The source physical layer 1005 verifies the CRC of the EPR_Request message, and then sends 1027 the EPR_Request message to the source protocol layer 1004.

The source protocol layer 1004 checks 1028 the MessageID of the Request message against a local copy (e.g., to make sure it is an expected next MessageID) and then stores a copy of this MessageID for future reference. The source protocol layer 1004 then provides 1029 the EPR_Request message to the source policy engine 1003. Further, the source protocol layer 1004 generates a GoodCRC message for the USB-PD sink 1002 (for acknowledging the receipt of the EPR_Request message) and then sends 1031 the GoodCRC message to the source physical layer 1005.

Upon receiving the Request message, the source policy engine 1003 stops 1030 its previously started SenderResponseTimer.

The source physical layer 1005 appends a CRC to the GoodCRC message and sends 1032 the GoodCRC message to the sink physical layer 1006.

The sink physical layer 1006 verifies the CRC of the GoodCRC message, and then sends 1033 the GoodCRC message to the sink protocol layer 1007.

The sink protocol layer 1007 checks 1034 that the GoodCRC message reports that a correct MessageID was used, and then increments the MessageIDCounter used by the USB-PD sink 1002 to generate MessageIDs. The sink protocol layer 1007 also stops the previously started CRCReceiveTimer. The sink protocol layer 1007 further informs 1035 the sink policy engine 1008 that the EPR_Request message was successfully sent to the USB-PD source 1001.

In response, the sink policy engine 1008 starts 1036 a SenderResponseTimer.

The source policy engine 1003 evaluates 1037 the EPR_Request message to identify the power level requested by the USB-PD sink 1002.

Upon determining that it can provide the power level represented in the EPR_Request message, the source policy engine 1003 instructs 1038 the source protocol layer 1004 to send an Accept message to the USB-PD sink 1002.

The source protocol layer 1004 generates the Accept message and sends 1040 the Accept message to the source physical layer 1005. Further, the source protocol layer 1004 starts 1039 a corresponding CRCReceiveTimer.

The source physical layer 1005 appends a CRC to the Accept message, and then sends 1041 the Accept message to the sink physical layer 1006.

The sink physical layer 1006 verifies the CRC of the Accept message, and then sends 1042 the Accept message to the sink protocol layer 1007.

The sink protocol layer 1007 checks 1043 the MessageID of the Accept message against the local copy (e.g., to make sure it is an expected next MessageID) and then stores a copy of this MessageID for future reference. The sink protocol layer 1007 then informs 1044 the sink policy engine 1008 that the Accept message has been received. Further, the sink protocol layer 1007 generates a GoodCRC message for the USB-PD source 1001 (for acknowledging the receipt of the Accept message) and then sends 1047 the GoodCRC message to the sink physical layer 1006.

Upon being informed of the receipt of the Accept message, the sink policy engine 1008 stops 1045 its previously started SenderResponseTimer. The sink policy engine 1008 further starts a PSTransitionTimer. The sink policy engine 1008 also reduces the current draw of the USB-PD sink 1002. The sink policy engine 1008 further prepares 1046 for a new power level that is to be provided by the USB-PD source 1001.

The sink physical layer 1006 appends a CRC to the GoodCRC message and sends 1048 the GoodCRC message to the source physical layer 1005.

The source physical layer 1005 verifies the CRC of the GoodCRC message, and then sends 1049 the GoodCRC message to the source protocol layer 1004.

The source protocol layer 1004 checks 1050 that the GoodCRC message reports that a correct MessageID was used, and then increments the MessageIDCounter used by the USB-PD source 1001 to generate MessageIDs. The source protocol layer 1004 also stops the previously started CRCReceiveTimer. The source protocol layer 1004 further informs 1051 the source policy engine 1003 that the Accept message was successfully sent to the USB-PD sink 1002.

The source policy engine 1003 further adjusts 1052 the power supply of the USB-PD source 1001 to match the negotiated power level.

The source policy engine 1003 then instructs 1053 the source protocol layer 1004 to send a PS_RDY message to the USB-PD sink 1002.

The source protocol layer 1004 generates the PS_RDY message and sends 1055 the PS_RDY message to the source physical layer 1005. Further, the source protocol layer 1004 starts 1054 a corresponding CRCReceiveTimer.

The source physical layer 1005 appends a CRC to the PS_RDY message, and then sends 1056 the PS_RDY message to the sink physical layer 1006.

The sink physical layer 1006 verifies the CRC of the PS_RDY message, and then sends 1057 the PS_RDY message to the sink protocol layer 1007.

The sink protocol layer 1007 checks 1058 the MessageID of the PS_RDY message against the local copy (e.g., to make sure it is an expected next MessageID) and then stores a copy of this MessageID for future reference. The sink protocol layer 1007 then informs 1059 the sink policy engine 1008 that the PS_RDY message has been received. Further, the sink protocol layer 1007 generates a GoodCRC message for the USB-PD source 1001 (for acknowledging the receipt of the PS_RDY message) and then sends 1061 the GoodCRC message to the sink physical layer 1006.

Upon being informed of the receipt of the PS_RDY message, the sink policy engine 1008 stops 1060 its previously started PSTransitionTimer. The sink policy engine 1008 also starts a SinkEPRKeepAliveTimer.

The sink physical layer 1006 appends a CRC to the GoodCRC message and sends 1062 the GoodCRC message to the source physical layer 1005.

The source physical layer 1005 verifies the CRC of the GoodCRC message, and then sends 1063 the GoodCRC message to the source protocol layer 1004.

The source protocol layer 1004 checks 1064 that the GoodCRC message reports that a correct MessageID was used, and then increments the MessageIDCounter used by the USB-PD source 1001 to generate MessageIDs. The source protocol layer 1004 also stops the previously started CRCReceiveTimer. The source protocol layer 1004 further informs 1065 the source policy engine 1003 that the PS_RDY message was successfully sent to the USB-PD sink 1002.

The source policy engine 1003 starts 1066 a SourceEPRKeepAliveTimer.

The transfer of power from the USB-PD source 1001 to the USB-PD sink 1002 then proceeds according to the new power level 1067 of the power contract that has been negotiated.

The power adapters disclosed herein may include one or more processors and/or controllers using instructions present thereon to implement one or more functionalities of each such power adapter as those functionalities are described herein. The instructions used by such processors and/or controllers may be stored on a non-transitory computer-readable storage medium on (or in communication with) such controllers and/or processors. It is anticipated that these processors and/or controllers (and associated non-transitory computer-readable instructions for use thereon) may be present in any embodiment disclosed herein (even if not explicitly discussed).

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims.

1. A power adapter, comprising:
a Universal Serial Bus (USB) Type-C (USB-C) receptacle configured to act as a USB Power Delivery (USB-PD) sink with a USB-PD source;
a socket in electrical communication with the USB-C receptacle configured to receive a removable barrel plug; and
a USB-PD controller in electrical communication with the USB-C receptacle and configured to communicate with the USB-PD source via the USB-C receptacle to request that power be provided at a desired direct current (DC) voltage by the USB-PD source to the USB-C receptacle;
wherein the USB-C receptacle and the socket are configured to deliver the power at the desired DC voltage between the USB-C receptacle and the socket.

2. The power adapter of claim 1, further comprising a buck-boost converter in communication with the USB-PD controller configured to keep the power at the desired DC voltage.

3. The power adapter of claim 1, wherein the socket is configured to receive one or more pins of the removable barrel plug.

4. The power adapter of claim 1, wherein the socket is shaped to receive the removable barrel plug with a correct orientation.

5. The power adapter of claim 1, wherein pin receptacles of the socket are arranged to receive pins of the removable barrel plug with a correct orientation.

6. The power adapter of claim 1, wherein the desired DC voltage is 20 volts.

7. The power adapter of claim 1, wherein the desired DC voltage is 9 volts.

8. The power adapter of claim 1, further comprising firmware that defines the desired DC voltage.

9. The power adapter of claim 1, further comprising filtering circuitry to filter the power prior to delivery of the power at the socket.

10. The power adapter of claim 1, further comprising protection circuitry to protect the power adapter from one of overcurrent, overvoltage, and a short circuit.

11. The power adapter of claim 1, further comprising a switch configured to allow a user of the power adapter to interrupt delivery of the power to the socket.

12. A method of a power adapter, comprising:
requesting, via a Universal Serial Bus (USB) Type-C (USB-C) receptacle of the power adapter, a USB Power Delivery (USB-PD) source connected to the USB-C receptacle to provide power at a desired direct current (DC) voltage to the USB-C receptacle;
receiving, from the USB-PD source, the power at the desired DC voltage at the USB-C receptacle; and
delivering the power at the desired DC voltage from the USB-C receptacle to a socket of the power adapter, wherein the socket is configured to receive a removable barrel plug.

13. The method of claim 12, further comprising keeping the power at the desired DC voltage using buck-boost circuitry.

14. The method of claim 12, further comprising determining the desired DC voltage based on a firmware for the power adapter.

15. The method of claim 12, further comprising filtering the power prior to delivering the power to the socket.

16. A non-transitory computer-readable storage medium, the computer-readable storage medium including instructions that when executed by one or more processors of a power adapter, cause the power adapter to:
request, via a Universal Serial Bus (USB) Type-C (USB-C) receptacle of the power adapter, a USB Power Delivery (USB-PD) source connected to the USB-C receptacle to provide power at a desired direct current (DC) voltage to the USB-C receptacle;
receive, from the USB-PD source, the power at the desired DC voltage at the USB-C receptacle; and
deliver the power at the desired DC voltage from the USB-C receptacle to a socket of the power adapter, wherein the socket is configured to receive a removable barrel plug.

17. The non-transitory computer-readable storage medium of claim 16, wherein the socket is configured to receive one or more pins of the removable barrel plug.

18. The non-transitory computer-readable storage medium of claim 16, wherein the socket is shaped such that it receives the removable barrel plug with a correct orientation.

19. The non-transitory computer-readable storage medium of claim 16, wherein pin receptacles of the socket are arranged to receive pins of the removable barrel plug with a correct orientation.

20. The non-transitory computer-readable storage medium of claim 16, wherein the instructions, when executed by the one or more processors, further cause the power adapter to determine the desired DC voltage based on a firmware for the power adapter.
